(19) United States
(12) Patent Application Publication
(10) Pub. No.: US 2020/0353759 A1
(43) Pub. Date: Nov. 12, 2020

(54) METHOD FOR MANUFACTURING THERMAL PRINT HEAD STRUCTURE

(71) Applicant: Chien Hwa Coating Technology , Inc., Hsinchu (TW)

(72) Inventors: Ming-Jia LI, Hsinchu (TW); Yi-Wei LIN, Hsinchu (TW); Chun-Chen CHEN, Hsinchu (TW)

(21) Appl. No.: 16/541,187

(22) Filed: Aug. 15, 2019

(30) Foreign Application Priority Data
May 8, 2019 (TW) 108115943

(51) Int. Cl. B41J 2/335

(52) U.S. Cl. CPC B41J 2/3359; B41J 2/33535; B41J 2/3356; B41J 2/3355; B41J 2/33525

(57) ABSTRACT

A method of manufacturing a thermal print head structure includes the following steps. A glaze layer, a heating resistor layer, an electrode layer and a photoresist layer are sequentially coated on a substrate, in which the photoresist layer has an arc ridge portion in accordance with the formation of the glaze layer. The arc ridge portion of the photoresist layer is partially removed such that a sunken portion is formed on the arc ridge portion. The photoresist layer is fully thinned to remove a bottom of the sunken portion, so that a local position of the electrode layer is revealed. The local position of the electrode layer is etched so that the heating resistor layer is partially revealed outwardly. The photoresist layer is removed from the electrode layer. A protective layer is formed on the electrode layer, the heating resistor layer, and the substrate.

### CROSS-REFERENCE TO RELATED APPLICATION

This application claims priority to Taiwan Application Serial Number 108115943, filed May 8, 2019, which is herein incorporated by reference.

### BACKGROUND

### Field of Disclosure

The present disclosure relates to a method for manufacturing a thermal print head structure.

### Description of Related Art

In the manufacturing process of the conventional thermal print head (TPH) element, a number of photolithography processes are required to be performed for forming a multilayer structure on a substrate, thereby, completing the finished product of the TPH element. Thus, not only the manufacturing process is complicated, but also cannot improve time, cost and process.

Furthermore, when the TPH element passes through various lithography processes such as photoresist coating, alignment, exposure and photoresist development, it may lead the alignment shift of mask to the TPH, thereby reducing the position accuracy of the photoresist development and increasing the probability of defect generation so as to affect the product yield of the TPH structure.

### SUMMARY

One aspect of the disclosure is to provide a method for manufacturing a thermal print head structure so as to solve the efficiencies mentioned in the prior art, that is, to reduce the number of lithography processes, thereby improving the position accuracy of the photoresist development and decreasing the probability of defect generation thereby improving the product yield of the thermal print head structure.

In one embodiment of the disclosure, a method of manufacturing a thermal print head structure is provided. The method of manufacturing a thermal print head structure includes the following steps. A glaze layer is formed on a substrate. A heating resistor layer is formed on the glaze layer and the substrate. An electrode layer is formed on the heating resistor layer. A photoresist layer is formed on one portion of the electrode layer, and the photoresist layer is formed with an arc ridge portion in accordance with the formation of the glaze layer. One portion of the arc ridge portion of the electrode layer is removed such that a sunken portion having a bottom therein is formed on the photoresist layer. Overlapping parts of the electrode layer and the heating resistor layer which are overlapped with each other and not covered by the photoresist layer are sequentially removed. A thickness of the photoresist layer is entirely thinned to remove the bottom of the sunken portion of the photoresist layer, so that a local position of the electrode layer is exposed outwardly from the photoresist layer. The local position of the electrode layer is etched so that the heating resistor layer is partially revealed outwardly from the photoresist layer. The photoresist layer is removed from the electrode layer. A protective layer is formed on the electrode layer, the heating resistor layer and the substrate.

According to one or more embodiments of the disclosure, in the method of manufacturing the thermal print head structure, the step of removing the portion of the arc ridge portion of the electrode layer further includes steps as follows. A half-tone mask is aligned to the photoresist layer. A semi-exposure procedure is performed to the arc ridge portion of the photoresist layer with the half-tone mask to form the sunken portion in which a vertical depth of the sunken portion is less than a thickness of the photoresist layer.

According to one or more embodiments of the disclosure, in the method of manufacturing the thermal print head structure, the step of aligning the half-tone mask to the photoresist layer further includes steps as follows. A full-exposure procedure is performed to an edge portion of the photoresist layer with the half-tone mask such that the edge portion of the photoresist layer is fully removed to expose the electrode layer from the photoresist layer.

According to one or more embodiments of the disclosure, in the method of manufacturing the thermal print head structure, the step of entirely thinning the thickness of the photoresist layer to remove the bottom of the sunken portion of the photoresist layer further includes a step as follow. The thickness of the photoresist layer is entirely thinned to remove the bottom of the sunken portion of the photoresist layer by a plasma ashing procedure.

According to one or more embodiments of the disclosure, in the method of manufacturing the thermal print head structure, the semi-exposure procedure is performed with the half-tone mask having 45-60% light transmittance.

According to one or more embodiments of the disclosure, in the method of manufacturing the thermal print head structure, the vertical depth of the sunken portion is 50% of the thickness of the photoresist layer.

According to one or more embodiments of the disclosure, in the method of manufacturing the thermal print head structure, the step of sequentially removing overlapping parts of the electrode layer and the heating resistor layer which are not covered by the photoresist layer further includes steps as follows. One of the overlapping parts of the electrode layer which is not covered by the photoresist layer is removed through a wet etching method such that a part of the heating resistor layer is revealed. The revealed part of the heating resistor layer is removed with a dry etching method.

According to one or more embodiments of the disclosure, the method of manufacturing the thermal print head structure further includes a step that the protective layer is partially etched such that a gap which exposes the electrode layer is formed on the protective layer.

According to one or more embodiments of the disclosure, in the step of forming the glaze layer of the method of manufacturing the thermal print head structure, the glaze layer includes at least one heat storing strip glass, and the heat storing strip glass is located on the substrate to overlap the arc ridge portion.

The above description is merely used for illustrating the problems to be resolved, the technical methods for resolving the problems and their efficacies, etc. The specific details of the disclosure will be explained in the embodiments below and related drawings.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure. In the drawings,

FIG. 1 is a flow chart of a method of manufacturing a thermal print head structure according to one embodiment of the disclosure;

FIG. 2A is an operational top view of Step 11 of FIG. 1;

FIG. 2B is a cross-sectional view viewed along a line A-A of FIG. 2A; and

FIG. 2C to FIG. 2P are detailed operational schematic views of Step 12 to Step 19.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts. According to the embodiments, it will be apparent to those skilled in the art that various modifications and variations can be made to the structure of the disclosure without departing from the scope or spirit of the disclosure.

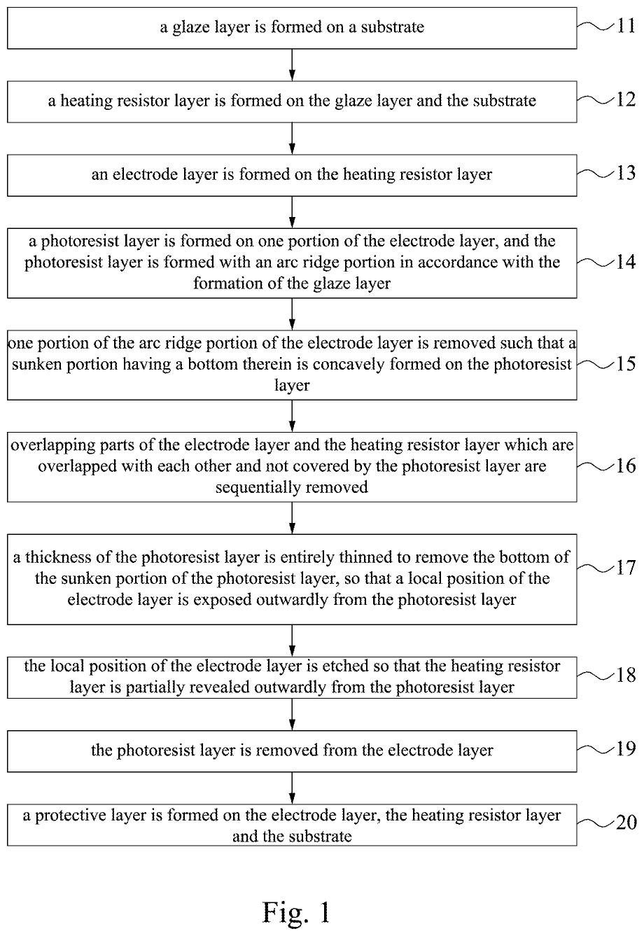

Reference is now made to FIG. 1, in which FIG. 1 is a flow chart of a method of manufacturing a thermal print head structure according to one embodiment of the disclosure. As shown in FIG. 1, the method of manufacturing a thermal print head structure includes step 1 to step 20 as follows. In step 11, a glaze layer is formed on a substrate. In step 12, a heating resistor layer is formed on the glaze layer and the substrate. In step 13, an electrode layer is formed on the heating resistor layer. In step 14, a photoresist layer is formed on one portion of the electrode layer, and the photoresist layer is formed with an arc ridge portion in accordance with the formation of the glaze layer. In step 15, one portion of the arc ridge portion of the electrode layer is removed such that a sunken portion having a bottom therein is concavely formed on the photoresist layer. In step 16, overlapping parts of the electrode layer and the heating resistor layer which are overlapped with each other and not covered by the photoresist layer are sequentially removed. In step 17, a thickness of the photoresist layer is entirely thinned to remove the bottom of the sunken portion of the photoresist layer, so that a local position of the electrode layer is exposed outwardly from the photoresist layer. In step 18, the local position of the electrode layer is etched so that the heating resistor layer is partially revealed outwardly from the photoresist layer. In step 19, the photoresist layer is removed from the electrode layer. In step 20, a protective layer is formed on the electrode layer, the heating resistor layer and the substrate.

Thus, by the aforementioned steps, the disclosure is able to reduce the number of lithography processes, thereby improving the position accuracy of the photoresist development and decreasing the probability of defect generation thereby improving the product yield of the thermal print head structure.

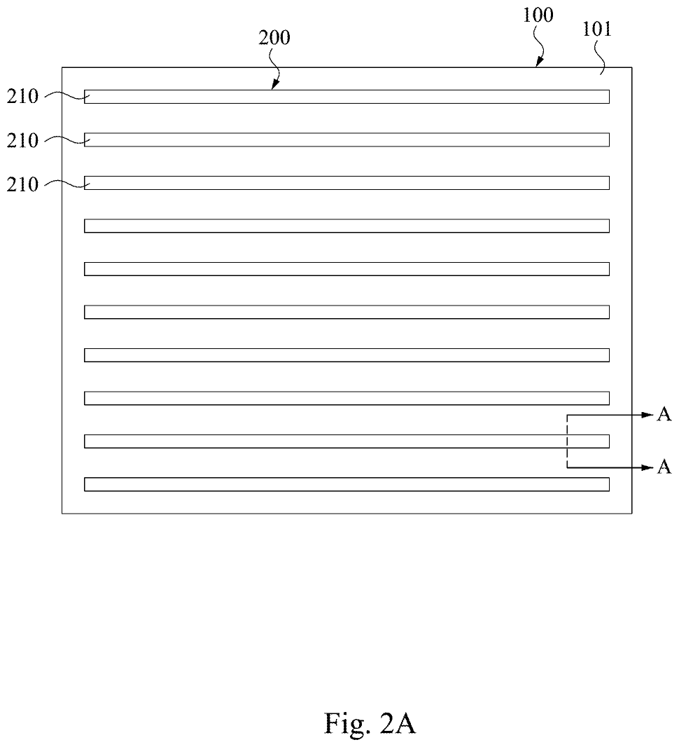

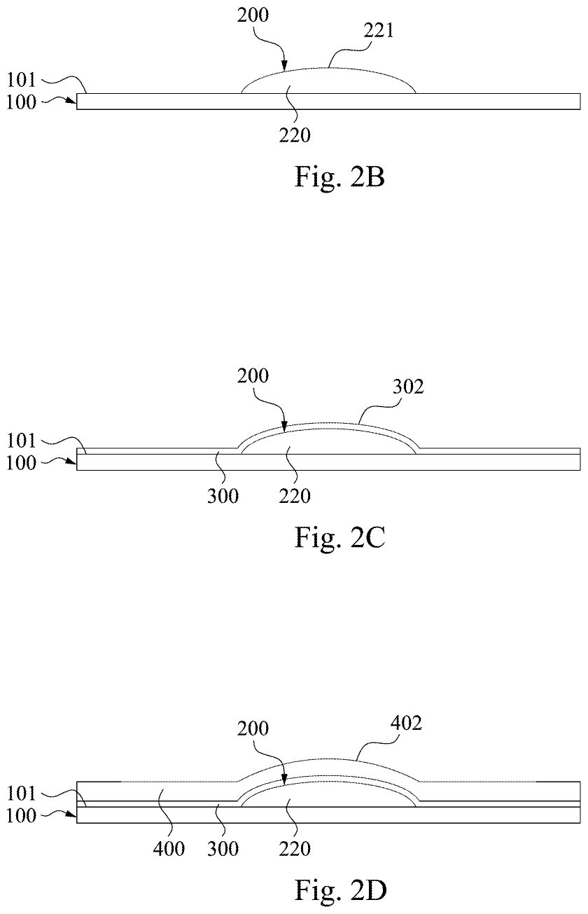

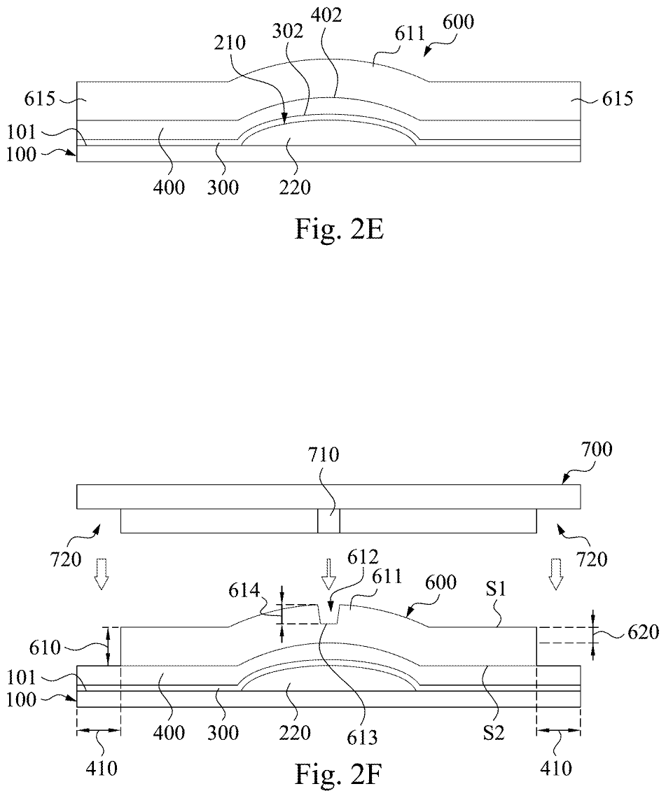

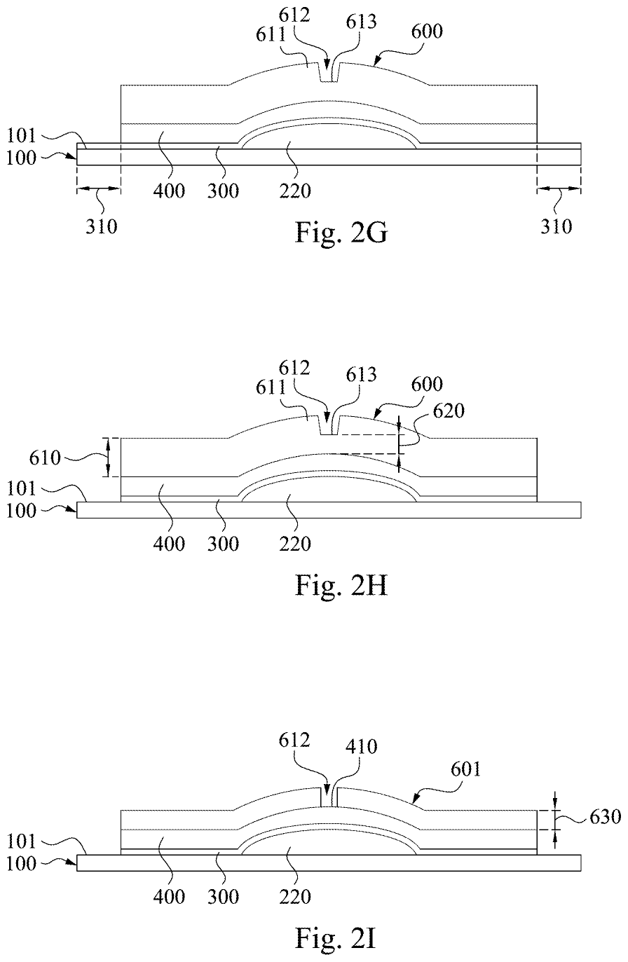

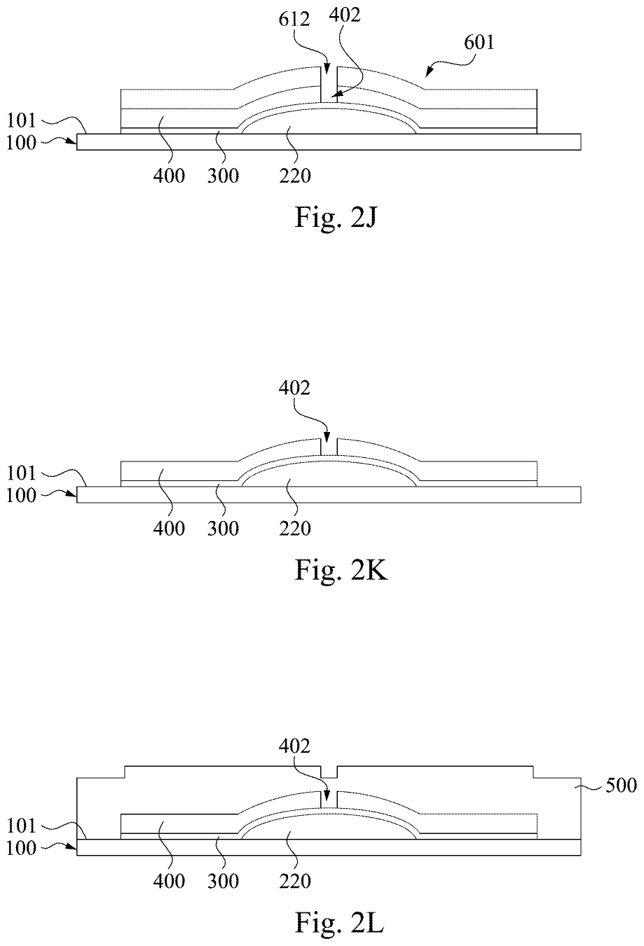

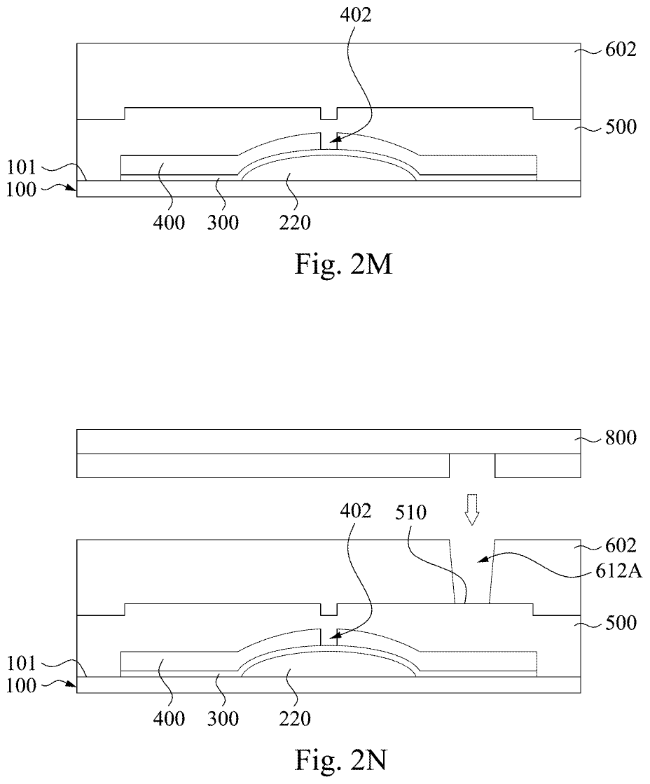

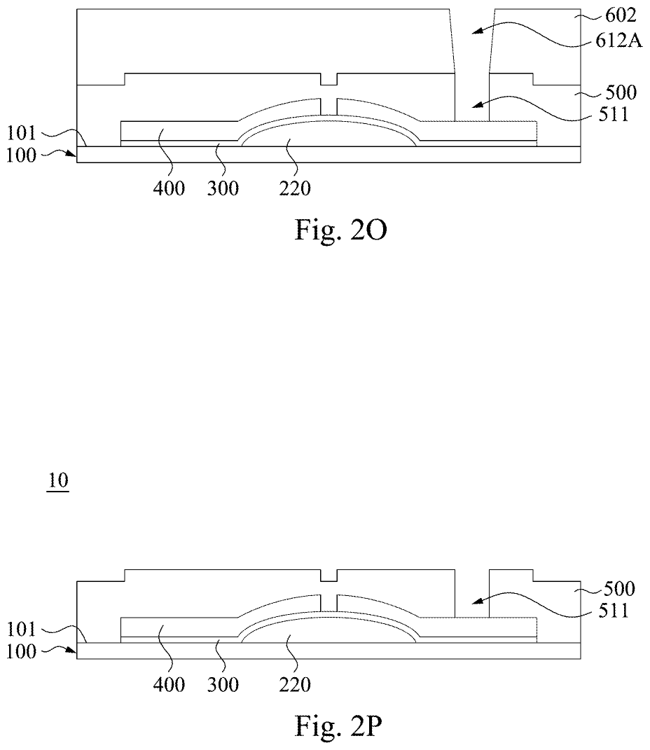

FIG. 2A is an operational top view of Step 11 of FIG. 1, and FIG. 2B is a cross-sectional view viewed along a line A-A of FIG. 2A. Specifically, as shown in FIG. 2A and FIG. 2B, the glaze layer 200 described in the step 11 includes a plurality of heat storing strip glasses 210. The heat storing strip glasses 210 are spaced arranged on a top surface 101 of the substrate 100 abreast in which the heat storing strip glasses 210 are linearly arranged and parallel to each other, and the top surface 101 of the substrate 100 is directly exposed from the space between any two adjacent heat storing strip glasses 210. Each of the heat storing strip glasses 210 has a raised portion 220 (e.g., bow shape) in cross section on the substrate 100, that is, the apex 221 of the raised portion 220 is furthest from the top surface 101 of the substrate 100. For example, the heat storing strip glass 210 is formed by printing a glaze paste on the substrate 100 by a screen-printing process and sintering the glaze paste at a high temperature. Furthermore, the substrate 100 is, for example, a ceramic or a silicon crystal substrate, but the disclosure is not limited to the material of the substrate 100.

FIG. 2C to FIG. 2P are detailed operational schematic views of Step 12 to Step 19. Specifically, as shown in FIG. 2C, the heating resistor layer 300 described in the step 12 covers both of the raised portion 220 and the top surface 101 of the substrate 100 collectively. Since the heating resistor layer 300 is coated on the raised portion 220, the heating resistor layer 300 forms a corresponding ridge shape 302 on the raised portion 220. For example, the heating resistor layer 300 is formed on the glaze layer 200 and the substrate 100 by a physical vapor deposition (PVD) method. The material of the heating resistor layer 300 is, for example, TaN group, TaO group, or the like, and the thickness of the heating resistor layer 300 is, for example, 0.2 to 2.0 μm.

Specifically, as shown in FIG. 2D, the electrode layer 400 described in the step 13 is coated on one surface of the heating resistor layer 300 facing away from the substrate 100. Since the electrode layer 400 is coated on the ridge shape 302 of the heating resistor layer 300, the electrode layer 400 is also formed into a corresponding ridge shape. For example, the electrode layer 400 is formed by a physical vapor deposition (PVD) method, and the material of the electrode layer 400 is, for example, copper, aluminum, or titanium, and the thickness of the electrode layer 400 is, for example, 0.3 to 2.0. μm.

Specifically, as shown in FIG. 2E, the photoresist layer 600 described in the step 14 is formed on one surface of the electrode layer 400 opposite to the substrate 100 through a coating and baking processes. Since the photoresist layer 600 is coated on a protruding outline 403 of the electrode layer 400, the photoresist layer 600 can also form the above-mentioned arc ridge portion 611, and the arc ridge portion 611 and the heat storing strip glasses 210 are parallel to and overlap with each other. For example, the photoresist layer 600 contains a photosensitive material. It should be understood that two opposite edge portions 615 of the photoresist layer 600 also cover the electrode layer 400 at this time.

Specifically, as shown in FIG. 2E and FIG. 2F, the step 15 further includes several detailed steps as follows. A half-tone mask 700 is moved and aligned to the photoresist layer 600 so as to perform an exposure procedure to one surface of the photoresist layer 600 opposite to the substrate 100 with the half-tone mask 700. Next, a semi-exposure procedure is performed to the arc ridge portion 611 of the photoresist layer 600 with the half-tone mask 700, and a full-exposure procedure is performed to the edge portions 615 of the photoresist layer 600.

It should be understood that when a process operator performs a full-exposure procedure to the photoresist layer 600 with the half-tone mask 700, the process operator irradiates the photoresist layer 600 with full light intensity by the half-tone mask 700 so that the corresponding locations of the photoresist layer 600 will be entirely removed. The light transmittance of the full-exposure procedure of the photoresist layer 600 with the half-tone mask 700 is, for example, 100% or 98 to 99%. For example, when the edge portions 615 of the photoresist layer 600 are irradiated with 100% of light intensity, the edge portions 615 of the photoresist layer 600 are completely removed.

Meanwhile, when the process operator performs a semi-exposure procedure to the arc ridge portion 611 of the photoresist layer 600 with the half-tone mask 700, the process operator irradiates the arc ridge portion 611 (i.e., the apex of the arc ridge portion 611) of the photoresist layer 600 with non-full light intensity by the half-tone mask 700, so that the corresponding locations of the photoresist layer 600 will be partially removed, rather than removed entirely. Thereby, forming the sunken portion 612 having the bottom 613 on one surface of the arc ridge portion 611 opposite to the substrate 100. A vertical depth 614 of the sunken portion 612 is less than a thickness 610 of the photoresist layer 600. For example, the vertical depth 614 of the sunken portion 612 is 50% of the thickness 610 of the photoresist layer 600 or more. The thickness 610 of the photoresist layer 600 is substantially the minimum linear distance (i.e., thickness 610) from one side S1 of the photoresist layer 600 facing away from the electrode layer 400 to another side S2 of the photoresist layer 600 contacted with the electrode layer 400. The light transmittance of the half-tone mask 700 to the photoresist layer 600 for the semi-exposure procedure is less than the light transmittance of the half-tone mask 700 to the photoresist layer 600 for the full-exposure procedure. For the semi-exposure procedure, the light transmittance of the half-tone mask 700 to the arc ridge portion 611 of the photoresist layer 600 is, for example, 45 to 60%. For example, when the arc ridge portion 611 of the photoresist layer 600 is irradiated by 50% of full light intensity of illumination, the arc ridge portion 611 is removed half of thickness (i.e., about 50%) in the direction from the apex of the arc ridge portion 611 towards the raised portion 220. Thus, the other half (i.e., 50%) of the arc ridge portion 611 which has a thickness 620 is remained.

In addition, when the light transmittance of the half-tone mask 700 to the photoresist layer 600 for the semi-exposure procedure is, for example, 47 to 58%, and if the thickness 610 of the photoresist layer 600 is, for example, 1.81 to 1.86 μm, the removing thickness of the arc ridge portion 611 being removed will be 8000 angstroms (A) to 10,000 angstroms (A) in the direction from the apex of the arc ridge portion 611 towards the raised portion 220.

More specifically, the half-tone mask 700 is formed with at least one first light-transmissive region 710 and a second light transmissive region 720. The first light-transmissive region 710 is a half transmissive film or a full transmissive film having a plurality of ink dots (halftone dots) which are adjusted in size or frequency to adjust the light penetration intensity of the exposure intensity. The second light transmissive region 720 is used to provide a full light intensity or at least almost a full light intensity of exposure to the photoresist layer 600.

Specifically, the step 16 further includes several detailed steps as follows. As shown in FIG. 2F and FIG. 2G, the portions 401 (FIG. 2F) of the electrode layer 400 that are not covered by the photoresist layer 600 are removed, respectively, so as to respectively reveal two portions 310 of the heating resistor layer 300. More specifically, the electrode layer 400 is patterned by an etching method (such as wet etching) so as to form a common electrode and individual electrodes (not shown in figures). Next, as shown in FIG. 2G and FIG. 2H, the portions 310 of the heating resistor layer 300 which are revealed are removed so as to reveal two portions of the top surface 101 of the substrate 100, respectively. More specifically, the portions 301 of the heating resistor layer 300 (FIG. 2G) are removed through an etching method (e.g., dry etching).

As shown in FIG. 2H and FIG. 2I, specifically, the step 17 further includes a detailed step that the thickness 610 of the photoresist layer 600 is entirely thinned to another thickness 630 by a full etching method so that the bottom 613 of the sunken portion 612 of the photoresist layer 600 is removed totally, that is, in the photoresist layer 601 which has been thinned (FIG. 2I), the sunken portion 612 has been sunken towards the electrode layer 400 to be in direct contact with the local position 410 of the electrode layer 400 so as to eliminate the bottom 613 of the sunken portion 612 (FIG. 2H) and reveal the aforementioned local position 410 of the electrode layer 400. For example, the thickness 610 of the photoresist layer 600 is entirely thinned by a plasma ashing procedure so that the thickness 630 of the photoresist layer 601 which has been thinned (FIG. 2I) is approximately or exactly 50% of the original thickness.

Specifically, in the step 18, as shown in FIG. 2I and FIG. 2J, since the aforementioned local position 410 of the electrode layer 400 is revealed from the sunken portion 612 of the photoresist layer 601, the aforementioned local position 410 of the electrode layer 400 is removed by an etching method (e.g., wet etching), so that the heating resistor layer 300 can be revealed from the sunken portion 612 through a gap 402 of the electrode layer 400 (FIG. 2J).

Specifically, as shown in FIG. 2J and FIG. 2K, the step 19 further includes the photoresist layer 601 which is remained in FIG. 2J is removed from the electrode layer 400, for example, the photoresist layer 601 is removed through solvents.

Specifically, the step 20 further includes several detailed steps as follows. As shown in FIG. 2L to FIG. 2P, the aforementioned protective layer 500 is formed on the electrode layer 400, the heating resistor layer 300 and the substrate 100 (FIG. 2L) by a chemical vapor deposition (CVD) method, so that the aforementioned protective layer 500 covers the electrode layer 400, the heating resistor layer 300 and the substrate 100. More specifically, the protective layer 500 directly contacts with the top surface 101 of the substrate 100 and fills into the gap 402 of the electrode layer 400 for directly contacting the electrode layer 400 and the heating resistor layer 300 in the gap 402. The material of the protective layer 500 is, for example, silicon oxynitride (SiON) system, silicon nitride (SiN) system, silicon carbide (SiC) system, diamond-Like carbon (DLC) system, etc., and the thickness thereof is, for example, 1 to 10 μm. Next, another photoresist layer 602 is formed again on one surface of the protective layer 500 facing away from the substrate 100 through the coating and baking process (FIG. 2M). For example, another photoresist layer 602 includes a photosensitive material. Next, a full exposure mask 800 is moved and aligned to the photoresist layer 602 so as to perform a full exposure procedure on a specific position of the photoresist layer 602 with the full exposure mask 800. Thus, since the specific position of the photoresist layer 602 is removed so as to form another recess 612A, so that a portion 510 of the protective layer 500 (FIG. 2N) is exactly revealed from the recess 612A (i.e., the removed region). Next, the protective layer 500 is locally etched to correspond to a specific position (i.e., the portion 510 of the protective layer 500) of the photoresist layer 602, so that an opening 511 (FIG. 2P) which exposes the electrode layer 400 is formed on the protective layer 500. Next, another photoresist layer 602 is removed. Therefore, the thermal head structure 10 described above is fabricated.

Although the disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A method for manufacturing thermal print head structure, comprising:
forming a glaze layer on a substrate;
forming a heating resistor layer on the glaze layer and the substrate;
forming an electrode layer on the heating resistor layer;
forming a photoresist layer on one portion of the electrode layer, wherein the photoresist layer is formed with an arc ridge portion in accordance with a formation of the glaze layer;
removing one portion of the arc ridge portion of the electrode layer such that a sunken portion having a bottom therein is formed on the photoresist layer;
sequentially removing overlapping parts of the electrode layer and the heating resistor layer which are overlapped with each other and not covered by the photoresist layer;
entirely thinning a thickness of the photoresist layer to remove the bottom of the sunken portion of the photoresist layer, so that a local position of the electrode layer is exposed outwardly from the photoresist layer;
etching the local position of the electrode layer so that the heating resistor layer is partially revealed outwardly from the photoresist layer;
removing the photoresist layer from the electrode layer; and
forming a protective layer on the electrode layer, the heating resistor layer and the substrate.

2. The method for manufacturing thermal print head structure of claim 1, wherein the step of removing the portion of the arc ridge portion of the electrode layer such that the sunken portion having the bottom therein is formed on the arc ridge portion further comprises:
aligning a half-tone mask to the photoresist layer; and
performing a semi-exposure procedure to the arc ridge portion of the photoresist layer with the half-tone mask to form the sunken portion, wherein a vertical depth of the sunken portion is less than a thickness of the photoresist layer.

3. The method for manufacturing thermal print head structure of claim 2, wherein the step of aligning a half-tone mask to the photoresist layer further comprises:
performing a full-exposure procedure to an edge portion of the photoresist layer with the half-tone mask such that the edge portion of the photoresist layer is fully removed to expose the electrode layer from the photoresist layer.

4. The method for manufacturing thermal print head structure of claim 2, wherein the step of entirely thinning the thickness of the photoresist layer to remove the bottom of the sunken portion of the photoresist layer further comprises:
entirely thinning the thickness of the photoresist layer by a plasma ashing procedure.

5. The method for manufacturing thermal print head structure of claim 2, wherein the semi-exposure procedure is performed with the half-tone mask having 45-60% light transmittance.

6. The method for manufacturing thermal print head structure of claim 2, wherein the vertical depth of the sunken portion is 50% of the thickness of the photoresist layer.

7. The method for manufacturing thermal print head structure of claim 1, wherein the step of sequentially removing the overlapping parts of the electrode layer and the heating resistor layer which are not covered by the photoresist layer, further comprises:
removing one of the overlapping parts of the electrode layer which is not covered by the photoresist layer through a wet etching method such that a part of the heating resistor layer is revealed; and
removing the part of the heating resistor layer which is revealed with a dry etching method.

8. The method for manufacturing thermal print head structure of claim 1, further comprising:
partially etching the protective layer such that a gap which exposes the electrode layer is formed on the protective layer.

9. The method for manufacturing thermal print head structure of claim 1, wherein in the step of forming the glaze layer, the glaze layer comprises at least one heat storing strip glass, and the heat storing strip glass is located on the substrate to overlap the arc ridge portion.
